(19) United States
(12) Patent Application Publication
(10) Pub. No.: US 2002/0032266 A1
(43) Pub. Date: Mar. 14, 2002

(54) Colorless, low-emission polymer

(76) Inventors: Elfriede Sextl, Geiselbach (DE); Frank Heindl, Rodenbach (DE); Hans-Josef Maier, Alzenau (DE)

Correspondence Address: SMITH, GAMBRELL & RUSSELL, LLP, ATTORNEYS AT LAW, SUITE 800, 1850 M STREET, N.W., WASHINGTON, DC, 20036, US

(21) Appl. No.: 09/840,935

(22) Filed: Apr. 25, 2001

(30) Foreign Application Priority Data
Apr. 27, 2000 (DE) 100 20 621.2

(51) Int. Cl. C08K 3/34

(52) U.S. Cl. 524/450

(57) ABSTRACT

Low-emission polymers that contain at least one zeolite of structural type ZSM-S.

### INTRODUCTION AND BACKGROUND

The present invention relates to colorless plastics that release only very small amounts of undesirable organic compounds due to the addition of special additives. In this context flavorants and odorants in particular are considered to be undesirable substances.

Plastics are becoming increasingly important in everyday life today. An increasingly large number of beverages and foods is transported and stored in plastic containers. For example, today one can discern a growing trend toward replacing multiuse glass bottles for all kinds of beverages by single use and also multiuse packaging made of plastics.

When plastic packaging is used for foods, strict requirements are imposed on the material. If the material emits flavorants and/or odorants, the flavor of the foods can be severely degraded. Even more serious would be the release of chemicals that could adversely affect the health of the consumer. These considerations have even greater importance in the packaging of drugs, which are subject to the strictest controls. Drugs must be kept sterile and sealed. This has the result that plastic packagings must first be disinfected by irradiation or heat treatment. In this treatment it is possible for undesirable substances to form and/or to be released from the plastic. Moreover, there are numerous opportunities for the use of low-emission plastics in order to achieve or increase acceptance by the consumer. For example, time and again emissions from furniture, carpets or carpet backing lead to complaints. The typical new car smell, which is produced by the emission of organic compounds from plastics used in vehicle interiors, is likewise frequently perceived as annoying.

Only very little is known about the chemical nature of these substances today. As a rule, they are low-molecular, volatile organic compounds. The emitted compounds can, for example, be unconverted monomers. In addition, oxidation products, decomposition products and other undesirable byproducts always form to a certain extent in the polymerization process and/or in further processing. There are a number of known methods for reducing the escape of undesirable substances from plastics. For the most part, these involve the use of adsorption agents that are incorporated into the plastic and that reduce the emission of releasable compounds. Examples of such adsorbents that can be mentioned include activated carbons, silica gels, clay minerals or activated aluminum oxide. Hydrophilic zeolites are other adsorption agents that can be used. The use of hydrophilic zeolites to remove trialkanolamines from polyolefins can be mentioned as one example (U.S. Pat. No. 4,859,733). However, these agents have the disadvantage that they rapidly lose their effect in wet environments. For this reason, their use in packaging for foods and beverages, which always have a more or less high water content, makes sense only in exceptional cases.

A process for reducing odorants and flavorants in the manufacture of water pipes made of polyethylene or polypropylene is described in EP 0522129. During the polymerization, thus during the manufacture of the plastic, a hydrophobic zeolite that has a molar Si/Al ratio of at least 35, preferably 200-500, and a minimum pore size of 5.5 Å and that absorbs more than 10 wt % water at 25° C. and a water vapor partial pressure of 4.6 torr is added in an amount of 10-1000 ppm.

The known method has the disadvantage that the plastics produced in this way acquire a yellow to brown color. This phenomenon is observed especially in the case of polyolefins, for example, polypropylene or polyethylene, as the polymer base material. This greatly restricts the area of use of the plastics, since in many areas, for example packaging of foods and beverages, colorless and clear materials are necessary. If the plastics are dyed, the brilliance of the new color can be adversely affected by the yellow to brown color that is already present. With the use as water pipes described in EP 0522129 this discoloration does not play any role, since in any case, carbon blacks that color the material black are as a rule added to these materials.

Therefore an object of the invention is to produce a plastic that on the one hand, does not emit any, or in any case, negligible amounts of undesirable substances and on the other hand, is itself colorless and thus has a clearly broader spectrum of use than the known plastics.

### SUMMARY OF THE INVENTION

The above and other objects of the present invention can be achieved by using colorless and low-emission plastics which contain at least one zeolite of structure type ZSM-5, which has a maximum water absorption capacity of 10 wt % with respect to the weight of the zeolite, at 25° C. and 4.6 torr.

### DETAILED DESCRIPTION OF INVENTION

The invention shows that the use of certain zeolites affords colorless plastics that emit very low amounts of undesirable substances.

So that zeolites can effectively absorb undesirable substances present in a plastic and can permanently bind them even in a humid or wet environment, the zeolites have a hydrophobic character. The adsorption capacity for water vapor under specific conditions can be used as a measure of the hydrophobicity. Zeolites that absorb no more than 10 wt %, preferably no more than 6 wt % water with respect to the weight of the zeolite at 25° C. and a water vapor partial pressure of 4.6 torr can be viewed as hydrophobic. The plastics in accordance with the present invention accordingly contain a zeolite with this property.

The present invention has determined that this property can be obtained by zeolites that are relatively low in aluminum. Thus, the zeolites that are used have a molar Si/Al ratio of at least 15, preferably from 50 to 500. The Si/Al ratio is determined by the generally known wet chemical method. In addition, the selected zeolites have a pore size of at least 5.5 Å in order to be able to absorb organic compounds and permanently bind them.

It has been noted that plastics containing a zeolite as described up to now frequently have a yellow to brown discoloration. This proves to be the case particularly with polypropylene plastics. It was found in experiments that this discoloration does not derive from the particular composition of the polymer base: the discoloration appeared repeatedly in polypropylene plastics of different manufacture.

On the other hand, it surprisingly turned out that these discolorations do not occur when a zeolite of structure type ZSM-5 is used. In this case one obtains a low-emission and colorless plastic. The definition and description of this structural type is found in W. M. Meier, D. H. Olson: Atlas of Zeolite Structure, 3^{rd} revised ed., Butterworth-Heinemann, London, 1992. The manufacture of zeolites of type ZSM-5 is described in P. A. Jacobs, J. A. Martens: Synthesis of High-Silica Aluminosilicate Zeolites (Stud. Surf. Sci. Catal. 33), Elsevier, Amsterdam.

The result achieved in accordance with the invention is surprising, since one can find no obvious reason why many low-aluminum zeolites give rise to a yellow to brown color when incorporated into a plastic, but zeolites of structure type ZSM-5 do not. For example, it can be shown that the aluminum content is not the source of the discoloration.

It is advantageous if the zeolites that are used are first completely freed of water by heating before they are incorporated into the plastic. In one embodiment of the invention a single zeolite of type ZSM-5 or mixtures of different zeolites with ZSM-5 structure can be added to the plastic.

So as not to adversely affect the properties of the plastic; for example, the elasticity or breaking strength, the average particle size of the zeolites should be less than 15 μm, advantageously between 0.5 and 12 μm. The invention shows that the weight fraction of the zeolite in the plastic that is necessary for the desired effect is dependent on the polymer material that is used. All in all, there is a range for the zeolite fraction from 0.01-10 wt % with respect to the weight of the plastic that is used, preferably from 0.1-2 wt %.

All conventional plastics can be used as base materials, for example polyvinyl chloride, polyethylene terephthalate, polystyrene, acrylonitrile butadiene styrene (ABS), polyesters, polyamides, polyethylene, HDPE, polypropylene, especially oriented polypropylene (OPP). In one embodiment, mixtures of different polymer materials can also be used. Typically, these plastics are thermoplastic materials.

The zeolites can be added to the plastics in the known way in the form of a so-called masterbatch or as a dry blend (dry powder). In the first instance a masterbatch is first prepared in a substantially known way from the base plastic and up to 50 wt % of the zeolite. In the next step, a mixture of the masterbatch and the base plastic in a ratio corresponding to the end concentration of the zeolite is prepared in standard equipment, for example, an extruder, and optionally further processed at the same time. In the addition of the zeolite as a dry blend, the mixing and further processing take place in the appropriate equipment. In both cases, it is unconditionally necessary that the zeolite be distributed uniformly in the polymer.

The invention also includes masterbatches that are used to produce the claimed plastics. These masterbatches can contain a zeolite fraction of up to 50 wt % with respect to the prepared masterbatch. The masterbatches can be produced from the base plastic and the zeolite as a dry blend, where the zeolite or zeolites are added to the plastic in molten state, and the mixture is thoroughly mixed.

Another feature of the invention resides in masterbatches for the production of plastics that are characterized by the fact that they contain at least one zeolite of structure type ZSM-5, which has a maximum adsorption capacity for water at 25° C. and 4.6 torr of 10 wt % with respect to the weight of the zeolite, and this zeolite is contained in a fraction of a maximum of 50 wt % with respect to the weight of the prepared masterbatch.

In one embodiment the plastics can be used as packaging material or packagings of all kinds for foods and drugs. This includes, for example, plastic cups, boxes, pockets , pouches, dishes, plastic bags, packaging coatings or films. The films can be used to make bags, pockets, etc. Very high demands are made on these packagings; for example, with respect to emissions, which are effectively suppressed by the addition of the zeolite with a hydrophobicity factor of at least 1.5.

The invention additionally concerns the use of the described plastics in any form that is found in the interior of motor vehicles; for example, as structural parts or decorative articles. In addition, the invention concerns the use of the plastic in the form of textile fibers and in products that wholly or partially consist of these textile fibers. These can be, for example, fabrics, clothing articles, carpets or carpet backing.

The plastics in accordance with the invention with the addition of zeolites of structure type ZSM-5, have the following advantages:

The plastics emit only very low amounts of undesirable substances even under humid conditions or in the presence of water, since the added zeolites selectively adsorb volatile organic substances because of their hydrophobic character.

The plastics in accordance with the invention are not discolored by the addition of the zeolites, but rather are colorless. Thus, the resulting plastics can be used in those areas in which transparent or colorless polymers are necessary. If the plastics are dyed, no adverse effect on the color arises that can be caused by a yellow or brown color that is already present.

### EXAMPLE

### Example 1

Production of a plastic with DAZ (high modulus); determination of degree of whiteness.

### Example 2

Production of a plastic with DAZ (low modulus); determination of degree of whiteness.

### Example 3

Production of a plastic with DAY (=comparison test) with a zeolite; determination of brown discoloration or degree of whiteness.

### Example 4

To determine how strongly the newly developed plastics emit volatile organic compounds without the addition of a zeolite, odor tests are carried out following the VDA (Association of the German Automotive Industry) recommendation 270 “Determination of the odor behavior of materials of vehicle interiors,” Variation C1 to C3. This procedure takes into account the behavior of the material under various effects of temperature and weather.

Embodiments:

Variation C1: In a 1-L, air-tight sealed glass 50 mL demineralized water and 50 mL (±5 mL) of the plastic (as film or granulate) are stored at 23° C. (±2° C.) for 24 h (±1 h) so that the plastic and the water are not in direct contact. The water serves to ensure that a high air humidity is present in the vessel. After 24 h 4 experienced testers evaluate the odor of the air according to the following scale:

Grade 1: not perceivable

Grade 2: perceivable, not annoying

Grade 3: clearly perceivable, but not yet annoying

Grade 4: annoying

Grade 5: highly annoying

Grade 6: unbearable

Variation C2: In a 1-L, air-tight sealed glass 50 mL demineralized water and 50 mL (±5 mL) of the plastic (as film or granulate) are stored at 40° C. (±2° C.) for 24 h (±1 h) so that the plastic and the water are not in direct contact. After 24 h 4 experienced testers evaluate the odor of the air according to the scale from variation C1.

Variation C3: In a 1-L, air-tight sealed glass 50 mL (±5 mL) of the plastic (as film or granulate) is stored at 80° C. (±2° C.) for 2 h (±10 min) without the addition of water. 4 experienced testers evaluate the odor of the air according to the scale from variation C1.

The evaluation result is given with reference to the test procedure (“VDA 270 odor test”) and the variation that is used (C1, C2 or C3) as the arithmetic mean of the individual grades, rounding off the average value to half grade values:

Example: VDA 270 odor test C1-Grade 3.5.

Further variations and modifications of the foregoing will be apparent to those skilled in the art and are intended to be encompassed by the claims appended hereto.

German priority application 100 20 621.2 is relied on and incorporated herein by reference.

We claim:

1. A colorless and low-emission plastic, comprising at least one zeolite of structural type ZSM-5, which has a maximum adsorption capacity for water at 25° C. and 4.6 torr of 10 wt % with respect to the weight of the zeolite.

2. The plastic as in claim 1, wherein the zeolite added to the plastic has a molar Si/Al ratio of at least 15.

3. The plastic as in claim 1, wherein the zeolite added to the plastic has a molar Si/Al ratio of from 50-500.

4. The plastic as in claim 1, wherein the zeolite fraction in the ready-to-use plastic is 0.01-10 wt %, with respect to the weight of the plastic that is used.

5. The plastic as in claim 2, wherein the zeolite fraction in the ready-to-use plastic is 0.01-10 wt %, with respect to the weight of the plastic that is used.

6. The plastic as in claim 1, wherein the zeolite fraction in the ready-to-use plastic is 0.01-2 wt %, with respect to the weight of the plastic that is used.

7. The plastic as in claim 2, wherein the zeolite fraction in the ready-to-use plastic is 0.01-2 wt %, with respect to the weight of the plastic that is used.

8. The plastic as in claim 3, wherein the zeolite fraction in the ready-to-use plastic is 0.01-2 wt %, with respect to the weight of the plastic that is used.

9. The plastic as in claim 4, wherein the zeolite fraction in the ready-to-use plastic is 0.01-2 wt %, with respect to the weight of the plastic that is used.

10. The plastic as in claim 1, wherein zeolite has an average particle size of less than 15 μm.

11. The plastic as in claim 1, wherein zeolite has an average particle size of between 0.5 and 12 μm.

12. The plastic as in claim 1, wherein the polymer is a member selected from the group consisting of polyvinyl chloride, polyethylene terephthalate, polystyrene, acrylonitrile butadiene styrene (ABS), polyester, polyamides, HDPE, polypropylene, especially oriented polypropylene (OPP), polyethylene and a mixture thereof with at least one other polymer material.

13. A packaging material for foods and/or drugs, formed of the plastic of claim 1.

14. A structural part or decorative object for the interior of a motor vehicles, which is wholly or partially of the plastic as in claim 1.

15. A textile fiber, which is formed wholly or partially of the plastic of claim 1.

16. A textile fiber product which is formed wholly or partially of the plastic as in claim 1.

17. A masterbatch for production of plastic, comprising a plastic containing at least one zeolite of structural type ZSM-5, which has a maximum adsorption capacity for water at 25° C. and 4.6 torr of 10 wt %, with respect to the weight of the zeolite, and this zeolite is contained in a fraction of a maximum of 50 wt % with respect to the weight of the ready-to-use masterbatch.
